(19) United States
(12) Patent Application Publication
(10) Pub. No.: US 2015/0090592 A1
(43) Pub. Date: Apr. 2, 2015

(54) SPLIT-SENSOR DIELECTROPHORETIC/MAGNETOPHORETIC CYTOMETER

(71) Applicant: The University of Manitoba, Winnipeg (CA)

(72) Inventors: Douglas Thomson, Winnipeg (CA); Gregory Bridges, Winnipeg (CA); Michael Butler, Winnipeg (CA); Marija Nikolic-Jaric, Winnipeg (CA); Elham Salimi, Winnipeg (CA); Tim Cabel, Narol (CA); Szymon Rzeszowski, Winnipeg (MB); Graham Ferrier, Toronto (CA); Katrin Braasch, Dugald (CA)

(21) Appl. No.: 14/506,883

(22) Filed: Oct. 6, 2014

Related U.S. Application Data
(63) Continuation of application No. PCT/IB2013/000838, filed on Mar. 11, 2013.
(60) Provisional application No. 61/608,767, filed on Mar. 9, 2012.

(51) Int. Cl. G01N 15/10; G01N 27/447

(52) U.S. Cl. CPC G01N 15/1031; G01N 27/44786; G01N 2015/1006
USPC 204/547; 204/643

(57) ABSTRACT

Embodiments of an improved sensor for dielectrophoretic cytometry are presented. In one embodiment, the sensor includes a plurality of sensor electrodes as well as an actuation electrode. Embodiments of microfluidic systems incorporating such sensor are also described. Additionally, embodiments of methods or performing cytometry analysis are also presented.

### CROSS-REFERENCE TO RELATED APPLICATIONS

This application claims the benefit of priority to U.S. Provisional Patent Application Ser. No. 61/608,767, filed Mar. 9, 2012, hereby incorporated by reference in its entirety.

### BACKGROUND OF THE INVENTION

1. Field of the Invention

This invention relates to cell analysis and more particularly relates to cytometry performed by a split-sensor dielectrophoretic/magnetophoretic (“DEP”) cytometer.

2. Description of the Related Art

Flow cytometry is used for high-thoughput cell-by-cell analysis. Conventional flow cytometers consist of hydrodynamic focusing and fluorescence-activated cell sorting (FACS) stages. FACS requires the use of fluorescent dyes for labeling specific features within individual cells. By using dyes with different emission spectra that preferentially stain different features, FACS allows distinguishing of the different cellular features. Each cell is optically excited, and the resultant fluorescence may be detected by an optical detector. The detector output is analyzed to measure such cellular properties as size, shape, viability, cycle phase, DNA content, and surface markers. One problem with FACS systems and other conventional flow cytometry systems is that they are typically expensive, bulky, intricate, and require regular maintenance by skilled technicians. Because of these issues, common flow cytometry systems are also not typically portable.

As a result of these problems with optical flow cytometry systems, some microfluidic systems have been developed for flow cytometry. One such system is illustrated in FIG. 1A. The prior art flow cytometry device of FIG. 1A illustrates a microfluidic structure having fluid inlets, fluid outlets and microfluidic channels. Additionally, the microfluidic cytometer of FIG. 1A illustrates a plurality of cytometry sensors, each in proximity to a fluid cross-channel.

A prior art sensor is illustrated in greater detail in FIG. 1B. The sensor of FIG. 1B includes a plurality of contact pads, each coupled to an electrode. In the system of FIG. 1A, the sensors as shown in FIG. 1B are arranged in a microelectrode array (MEA). Such a system would use the MEA to simultaneously actuate and detect bioparticles. A pressure differential controls the flow of bioparticles through the microfluidic channel. Although the system of FIG. 1A has been used with optical sensing, it was also configured as a capacitive cytometer. In the configuration shown in FIG. 1B, the sensor includes a capacitance sensor coupled to the signal-ground (S-G) MEA to produce a sense signal. It was intended that the sense signal would be proportional to the transient MEA capacitance perturbations induced by passing bioparticles. In this configuration, an actuation signal is applied to the MEA simultaneously with sensing the cells or particles. Further details of the prior art system of FIGS. 1A-B are described in S. Romanuik, “a microflow cytometer with simultaneous dielectrophoretic actuation for the optical assay and capacitive cytometry of individual fluid suspended bioparticles,” Thesis, University of Manitoba (2009), which is incorporated herein in its entirety.

The sensor of FIG. 1B has several drawbacks. First, this sensor configuration does not easily detect subtle changes in the characteristics of a cell, such as viability, and therefore does not provide sufficient data to determine an estimation of the properties of the incoming particle. For example, as a cell becomes non-viable, the concentration of ions in the cell becomes lower. The sensor of FIG. 1B is not able to accurately detect this change in ion concentration, because sensor signals and actuation signals occur when simultaneously sensing and actuating the particle with the same MEA. Additionally, the interpretation of results generated by the sensor of FIG. 1B is challenging, due in part to the mixing of sensor signals during simultaneous actuation.

### SUMMARY OF THE INVENTION

Embodiments of an improved sensor for dielectrophoretic cytometry are presented. In one embodiment, the sensor includes a plurality of sensor electrodes as well as an actuation electrode. Embodiments of microfluidic systems incorporating such sensor are also described. Additionally, embodiments of methods for performing cytometry analysis are also presented.

In some aspects, provided are apparatuses comprising a first sensor electrode configured to sense a physical property of an analyte at a first time; a second sensor electrode configured to sense a physical property of an analyte at a second time; and an actuation electrode disposed between the first sensor electrode and the second sensor electrode and configured to apply an actuation force to one or more objects in the analyte.

In some embodiments, the actuation electrode is configured to apply a dielectrophoretic force to a cell in the analyte. In other embodiments, the dielectrophoretic force is configured to act upon the cell in response to one or more dielectric properties of the cell. In other embodiments the dielectrophoretic force is configured to act upon the cell in response to one or more physiological states of the cell. In yet other embodiments, the physiological states reflect the onset of programmed cell death.

In some embodiments, the actuation electrode is configured to apply a magnetophoretic force to a cell in the analyte. In other embodiments, the magnetophoretic force is configured to act upon the cell in response to a magnetic change in the cell. In other embodiments, the magnetophoretic force is configured to act upon the cell in response to one or more physiological states of the cell. In yet other embodiments, the physiological states reflect the onset of programmed cell death.

In some embodiments, the first and second sensor electrodes comprise ground and signal portions. In other embodiments, each of the actuator electrode, and ground and signal portions of the first and second sensor electrodes has a width of about 25 μm. In other embodiments, the ground and signal portions are separated from one another by a gap. In further embodiments, the gap is about 25 μm.

In some aspects, provided are systems comprising: a fluid inlet configured to receive an analyte fluid comprising one or more objects; a fluid outlet configured to dispense of the analyte fluid; a sensor element comprising: a first sensor electrode configured to sense a physical property of the analyte fluid at a first time; a second sensor electrode configured to sense a physical property of an analyte fluid at a second time; and an actuation electrode disposed between the first sensor electrode and the second sensor electrode and configured to apply an actuation force to one or more objects in the analyte fluid; and a fluid channel coupling the fluid inlet to the fluid outlet, and configured to provide at least a portion of the analyte fluid to the sensor element.

In some embodiments, the system additionally comprises two or more signal generator circuits, each signal generator circuit being coupled to one or more electrodes. In other embodiments, at least one sensor electrode is coupled to a first signal generator. In other embodiments, the first signal generator is configured to supply a signal having a frequency of between 0.1-20 MHz. In other embodiments, the actuator electrode is coupled to a second signal generator. In yet other embodiments, the second signal generator is configured to supply an electronic signal having a frequency of about 1.29 GHz.

In some aspects, provided are a methods comprising: sensing a physical property of an object in an analyte fluid with a first sensor electrode at a first time; applying an actuation force to the object in the analyte fluid; and sensing the physical property of the object in the analyte fluid with a second sensor electrode at a second time.

In some embodiments, the actuation force is applied by an electromagnetic signal. In other embodiments, the electromagnetic signal has a frequency of between 0.1 and 20 MHz. In other embodiments, the object in the analyte fluid is a cell.

In some embodiments, the methods further comprise analyzing a first sensor signal provided by the first sensor electrode and a second sensor signal provided by the second sensor electrode to quantify the physical property of the object in the analyte fluid. In other embodiments, the methods further comprise analyzing a first sensor signal provided by the first sensor electrode and a second sensor signal provided by the second sensor electrode to classify the physical property of the object in the analyte fluid.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1A illustrates a microfluidic system for cytometry according to the prior art.

FIG. 1B illustrates a sensor for microfluidic cytometry according to the prior art.

FIG. 2 is a schematic top view diagram illustrating one embodiment of a system for microfluidic DEP cytometry.

FIG. 3 is magnified photograph of one embodiment of a system for microfluidic DEP cytometry.

FIG. 4 is a magnified photograph of the top view of one embodiment of a microfluidic dual probe cytometry sensor.

FIG. 5 illustrates a cross-section side view of one embodiment of a microfluidic dual-probe cytometry sensor and the flow path of a particle over the sensor.

FIG. 6 illustrates the reaction of a viable and a non-viable particle in the presence of a DEP actuation force.

FIG. 7A illustrates a side view showing the introduction of a cell or particle to the sensor.

FIG. 7B illustrates a side view showing the flow path of a viable cell and a non-viable cell in response to application of a DEP actuation signal on the actuation electrode.

FIG. 8A illustrates one embodiment of a sensor readout for a sample where no actuation signal is applied.

FIG. 8B illustrates on embodiment of a sensor readout for a viable cell where an actuation signal is applied.

FIG. 8C illustrates an embodiment of a sensor readout for a non-viable cell where an actuation signal is applied.

FIG. 9 illustrates a comparison of the performance of a variety of cytometry techniques over a set period of time.

FIG. 10a illustrates experimental signatures produced by CHO cells entering an actuation region at about the same altitudes with similar velocities, but actuated in a different way depending on the frequency of the applied signal.

FIG. 10b illustrates sample signatures produced by unactuated CHO cells at flow rates of nl/s and cell density of 0.5×10⁶ cells/ml.

FIG. 10c illustrates signatures for a similar flow rate produced by actuated CHO cells.

FIG. 11a illustrates detection of early stage apoptosis by DEP cytometry after a culture was maintained for 96 hours with additional sampling at 108 hours and 120 hours.

FIG. 11b illustrates viability estimates of different assays plotted against viability estimates provided by DEP cytometry.

### DETAILED DESCRIPTION

Various features and advantageous details are explained more fully with reference to the nonlimiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

An all-electronic approach integrated with microfluidics to produce a portable low power instrument for determining the physiological status of a cell is described. Embodiments of systems that can use dielectric differentiation to analyze other properties such as the onset of apoptosis are also described. Physiological changes that results in changes to cell ion concentrations, cell dielectric properties, or cell morphology can be monitored using this approach.

It is possible to explore the electric properties of cells because any biological cell, regardless of its origin or type, is densely packed with ions and charged or polar molecules, distributed throughout the cell and often compartmentalized within membrane-bound cellular organelles. The presence of an externally applied electric field will induce individual free charges to move and orient and perturb the bound charges within the cell. In addition, a viable cell is an out-of-equilibrium system that communicates with its environment and controls the membrane transport of its electrolytes via ATP-activated membrane-bound proteins (known as ionic channels); capacitance and conductivity of cell membrane are both affected by ATP-dependent changes in influx and efflux of ions. Therefore, changes in metabolic or physiological state of the cell lead to changes in polarizability of the cell, which, in turn, directly influence the response of the cell to the surrounding electric field. A way to macroscopically register the presence of a cell in a volume of a fluid permeated by an electric field is to measure a change in capacitance of this volume, ΔC, as the cell flows through it and momentarily displaces the liquid. Amplitude of the electronic signature produced by the cell is directly proportional to the change in capacitance, S ∝ΔC.

The change in capacitance of a detector-electrode pair may be represented as

$$Δ C = 3 {ɛ}_{m} V Re \{ {K}_{CM} \} \frac{{E}_{rms}^{2}}{{U}_{rms}^{2}} ,$$

where εₘ is the (real) dielectric permittivity of the fluid medium, Vis the volume of the cell, Eᵣₘₛ and Uᵣₘₛ are the root-mean-squared values of the magnitude of the applied electric field and the voltage applied to the electrodes, respectively, and K_{CM} represents the Clausius-Mossotti factor, generally a complex quantity of the form

$${K}_{CM} = \frac{{\tilde{ɛ}}_{p} - {\tilde{ɛ}}_{m}}{{\tilde{ɛ}}_{p} + 2 {\tilde{ɛ}}_{m}} .$$

The Clausius-Mossotti factor (CMF) expresses the cell polarizability per unit volume relative to that of the surrounding medium at a given (angular) field frequency ω. The frequency dependence comes in through the complex dielectric permittivities of the cell and the medium, \tilde{ε}ᵢ where i=p, m:

$${\tilde{ɛ}}_{i} = {ɛ}_{i}^{′} - j {ɛ}_{i}^{″} - \frac{j}{ω} {σ}_{i} ,$$

which represent the ability of the material to polarize εᵢⁱ, but also account for the losses associated with different polarization mechanisms. (In the above, j is the imaginary unit.) Specifically, these losses may result from the viscosity hindering rotation of dipoles εᵢⁱⁱ, or from the finite time required to build up charges on the membranes (σᵢ). At certain frequencies discussed herein, it is safe to assume that σᵢ>>ωεᵢⁱⁱ, and consequently the term jεᵢⁱⁱ can be neglected. For convenience, the prime symbol on the real part of dielectric permittivity is also omitted herein (εᵢ^{j}→εᵢ).

Cell actuation may be accomplished using the dielectrophoretic (“DEP”) force. In a non-uniform electric field, a cell is subject to a force directed along the field gradient, expressed as

$${F}_{DEP} = \frac{3}{2} {ɛ}_{m} V Re \{ {K}_{CM} \} ∇ ( {E}_{rms}^{2} ) .$$

The DEP force is directly related to the polarizability of a cell in a given medium and can be oriented with or against the field gradient (pDEP or nDEP) depending on the sign of Re{K_{CM}}. DEP force depends, in general, on both conductive and dielectric properties of the suspending medium and the particle (cell), with the relative importance of these properties being highly dependent on frequency.

Certain embodiments of the present method comprise using an electronic detection that allows observation and quantification of individual variations between cells belonging to a population. To this end, certain embodiments employ a coplanar differential electrode array, fabricated at the bottom of a microfluidic channel. Altitudes of cells are detected using a gigahertz frequency field as the cells flow above the array, first at the entrance to the electrode region and again at the exit. This generates an electronic signature, S. In between these two detection regions, cells are actuated by a megahertz frequency field, resulting in change in cell altitude within the microfluidic channel. This modulates the amplitude of the signature S upon detection by a detector at the exit of an electrode region.

The amplitude of the electronic detection signature, S, depends on the spatial configuration of the (non-uniform) electric field, and therefore on the altitude of the cell measured from the coplanar electrode array. Thus, any modulation of the detection signature can be related to a simple physical variable, such as the amount of vertical cell translation during actuation. In addition, S is proportional to the size of the cell and its polarizability within a given suspension medium. Both of these factors can be offset by normalizing the signature S to its average amplitude.

Unlike the change in capacitance and the electronic signature, the DEP force strongly depends on the amplitude of the electric field. This permits detection of cells at one frequency and simultaneous actuation at another while keeping the two events clearly separate. Accordingly, in certain embodiments, the detection electrodes are energized by an intentionally low voltage (upper limit ˜300 mV); this ensures negligible DEP actuation at gigahertz frequency without any significant effect on detection signal-to-noise ratio. By contrast, in certain embodiments, the actuation electrodes may be energized with voltage amplitude at least 10 times higher. In some embodiments, the actuation electrodes are energized at a low frequency of 0.1-20 MHz with signals having an amplitude U_{A} typically greater than 1Vₚₚ. The resulting DEP force in the megahertz region prevails by two orders of magnitude and effectively accounts for the entire particle displacement due to actuation.

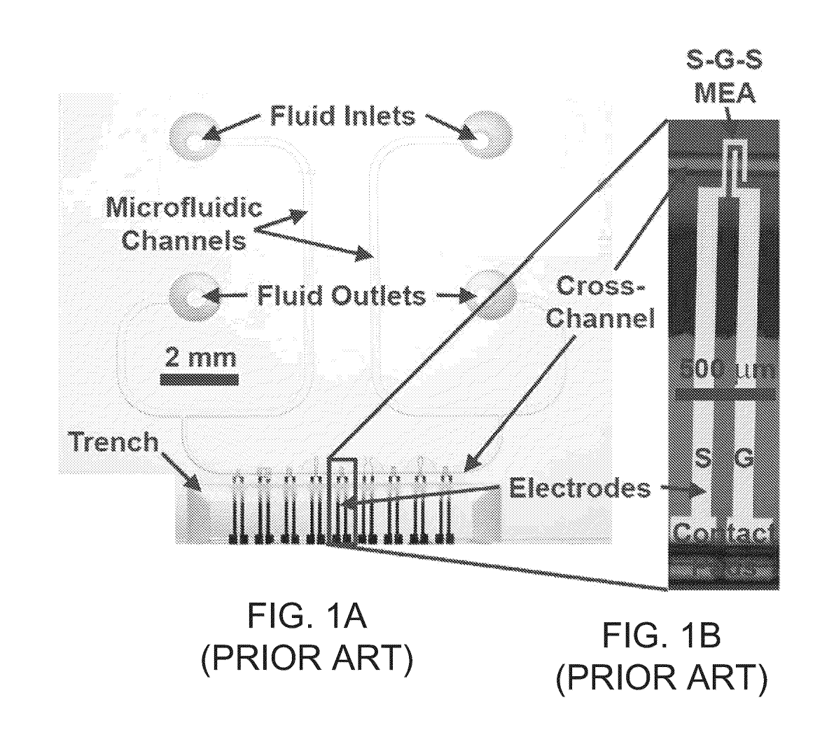

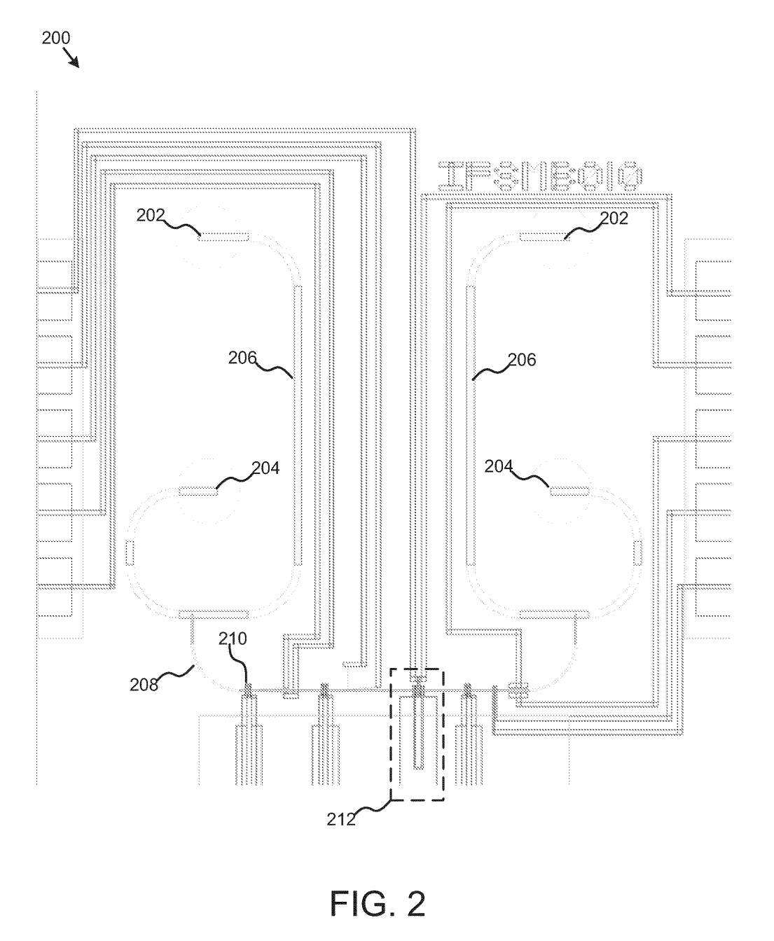

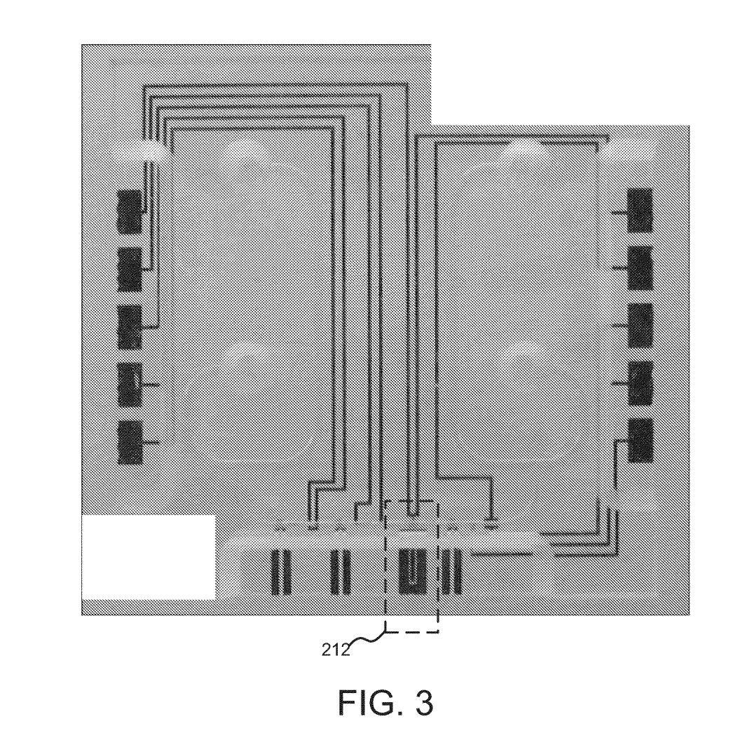

FIG. 2 is a schematic top view diagram illustrating one embodiment of a system 200 for microfluidic DEP cytometry. In the depicted embodiment, the system 200 includes a plurality of fluid inlets 202, each coupled to a fluid outlet 204 by a microfluidic channel 206. In one embodiment, the system 200 may also include a cross-channel 208 coupled between the two microfluidic channels 206. The cross-channel 208 may traverse one or more sensor elements 210, 212. In a particular embodiment, a plurality of different types of sensor elements 210 and 212 may be included in the system 200. For example, a sensor 210 as described in FIG. 1B may be included in addition to a multi-electrode sensor 212 as described herein. In such embodiments, a fluid sample comprising cells or particles may be analyzed by the sensor elements 210 and/or 212. In a particular embodiment, the cells or particles may be analyzed on an individual basis through a dielectrophoretic actuation. In a particular embodiment, cell viability may be analyzed on a cell-by-cell basis by the present system 200. An embodiment of the system 200 is further illustrated in the photograph of FIG. 3.

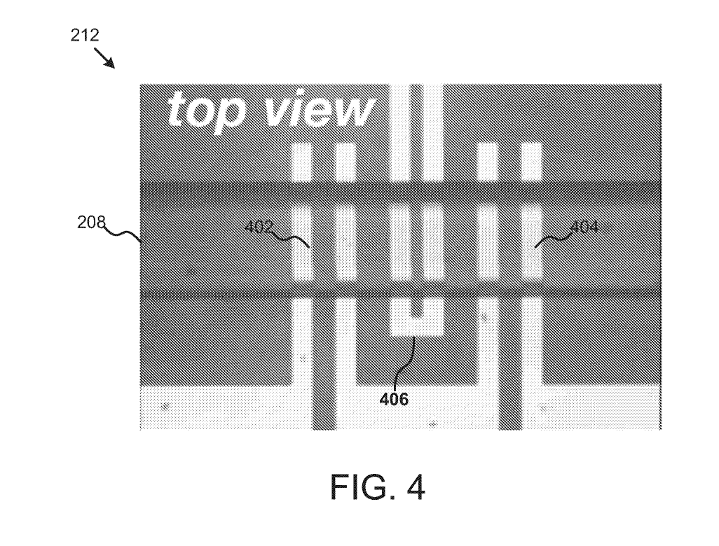

FIG. 4 is a magnified photograph of the top view of one embodiment of a microfluidic dual probe cytometry sensor 212. In a particular embodiment, the sensor 212 may include a first sensor electrode 402 and a second sensor electrode 404. In one embodiment, a actuation electrode 406 may be disposed between the first sensor electrode 402 and the second sensor electrode 404. Additionally, the microfluidic cross-channel 208 may traverse at least a portion of each of the first sensor electrode 402, the second sensor electrode 404, and the actuation electrode 406. In the embodiment depicted, each of the sensor electrodes 402, 404 comprises a ground electrode, 403, 405.

In certain embodiments, each electrode in the array may be 25 μm wide; dividing the central actuation electrode, the gap may be 15 μm, dividing the first sensor electrode may be a gap of 25 μm, dividing the second sensor electrode may be a gap of 25 μm and the actuation electrode may be separated from the first and second sensor electrodes by a space of 35 μm. In some embodiments, electronic signatures may be obtained by capacitive detection at 1.29 GHz by the first and second sensor electrodes and by actuated (using the actuation electrode) by a DEP force at 0.1 MHz. In some embodiments, the first and second sensor electrodes may be separated by 210 um from respective gap to respective gap.

In some embodiments, electrodes are fabricated on the bottom of the cross-channel 208 by sputtering a 180 nm thick gold layer on a 20 nm adhesion layer. Referring back to FIG. 3, it can be seen that electrodes of the first and second sensor electrodes may extend into wider electrode pads to provide a contact for the electrode wires extending from a microwave resonator. Ground electrodes may also join one another and extend to a wider pad.

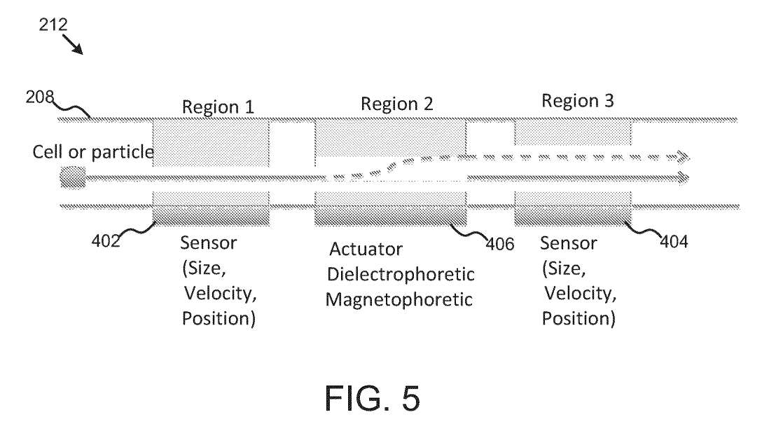

FIG. 5 illustrates a cross-section side view of one embodiment of a microfluidic dual-probe cytometry sensor 212 and the flow path of a particle over the sensor 212. In one embodiment, the cell or particle may be introduced to the censor through a pressure differential in the cross-channel 208. The cross-channel 208 may include a first region (Region 1) which is adjacent to at least a portion of the first sensor electrode 402. The first sensor electrode 402 may sense, for example, the size, velocity, and/or position of the cell or particle. As the cell or particle continues to flow through the cross-channel 208, the actuation electrode 406 may apply either an electricfield or a magnetic field in Region 2 of the cross-channel 208. The actuation field applied by the actuation electrode may cause the cell or particle to change trajectory based upon physical properties of the cell or particle. The cell or particle may then continue to flow into Region 3 of the cross-channel 208, which is adjacent at least a portion of the second sensor electrode 404. A second set of readings may be taken at the second sensor electrode 404 to determine, for example, the size, velocity, and/or position of the cell or particle. Any changes in cell size, velocity, or position may be used by a processing device (not shown) to calculate one or more properties associated with the cell or particle. Specific details with regard to embodiments of processing techniques that may be implemented by a computer or processing device are described in Appendix A.

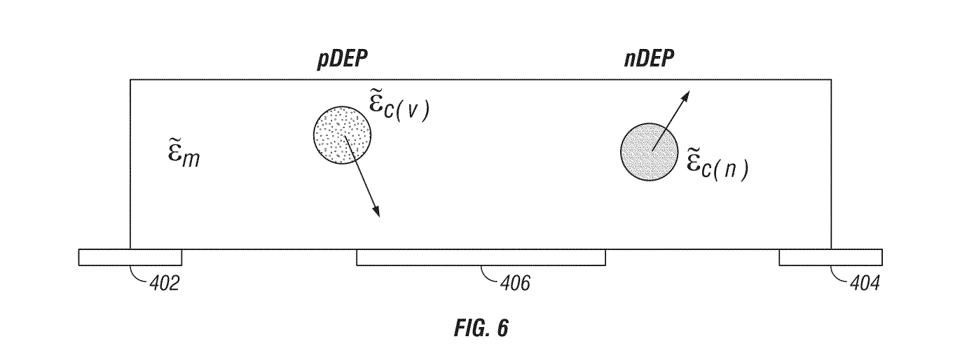

FIG. 6 illustrates the reaction of a viable and non-viable particle in the presence of a DEP actuation force. In one embodiment, a viable cell may be drawn closer to the actuation electrode 406 in the presence of an actuation field. The frequency of the DEP actuation force may be tuned in order to sense various physical properties of the cell. For example, a relatively low frequency (100 kHz-10 MHz) may cause the DEP cytometry to be sensitive to ionic content in the cells. If the cell is more polarizable than the fluid medium, due to high ionic content, then the cell may be pulled toward the actuation electrode 406. Such a process may be referred to as pDEP. If the cell is less polarizable than the medium, then the cell may be pushed away from the actuation electrode 406 in a process referred to as nDEP. Thus, based upon the ionic content of the cell, there may be a change in the trajectory of the cell in the presence of an actuation force. Advantageously, such a process may not require markers for determination of individual cell viability.

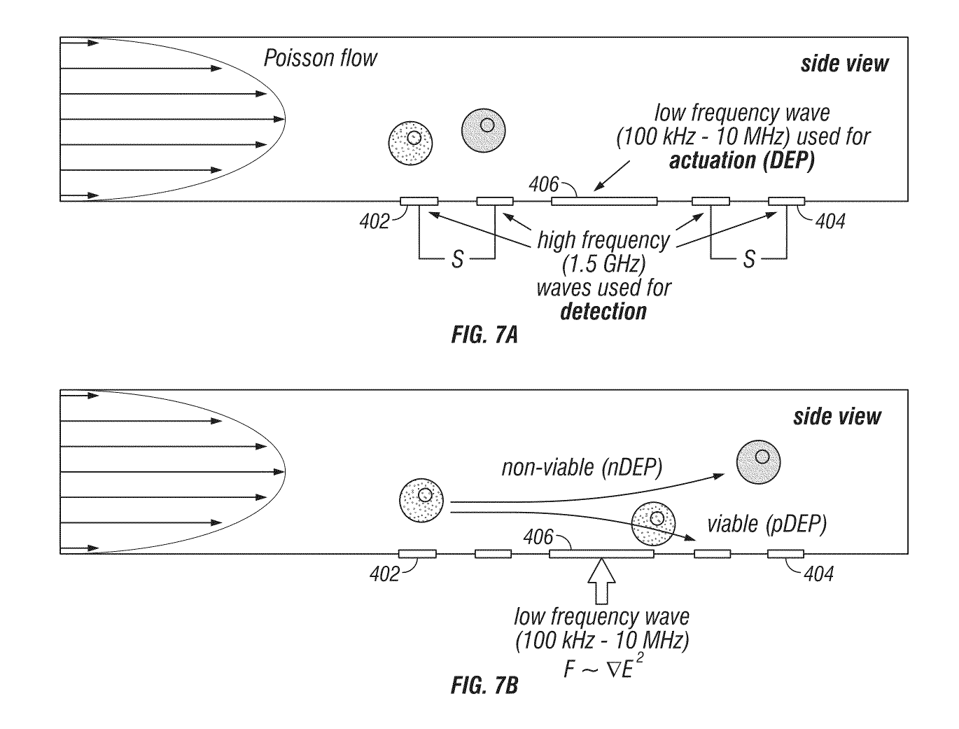

FIG. 7A illustrates a side view showing the introduction of a cell or particle to the sensor 212. In such an embodiment, the cell is introduced to Region 1, adjacent the first sensor electrode through Poisson flow of fluid in the cross-channel 208. The first sensor electrode may take a first reading of one or more physical properties of the cells in the fluid. Continued Poisson flow may cause the cell or particle to travel through Region 2 where an actuation force is applied by the actuation electrode 406. Further Poission flow, and the actuation force applied by the actuation electrode may cause the cell or particle to travel at an adjusted trajectory, as shown in FIG. 7B. FIG. 7B illustrates a side view showing the flow path of a viable cell and an non-viable cell in response to application of a DEP actuation signal on the actuation electrode 406. In such an embodiment, a second reading may be taken at the second sensor electrode 404. In a further embodiment, the readings may be compared and analyzed by a processing device to determine, for example, the viability count of cells in the fluid.

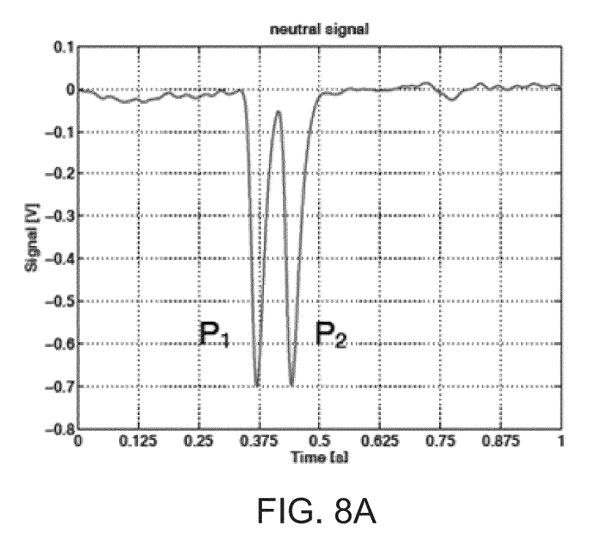

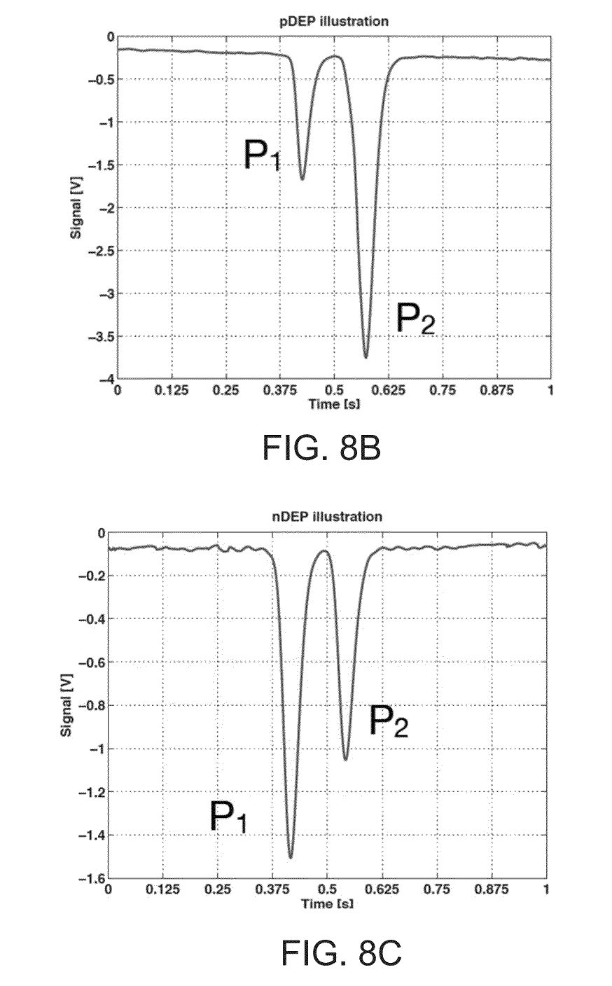

FIG. 8A illustrates one embodiment of a sensor readout for a sample where no actuation signal is applied. As illustrated in this figure, the peaks P₁ and P₂ correspond to sensor signals from the first sensor electrode 402 and the second sensor electrode 404 respectively. In one embodiment, there may very little difference in P₁ and P₂ where no actuation force is applied to the cell or particle. On the other hand, as illustrated in FIGS. 8B-C, the difference in P₁ and P₂ may be more observable when an actuation force is applied to the cell or particle. FIG. 8B illustrates one embodiment of a sensor readout for a viable cell where an actuation signal is applied. Because a viable cell would tend to be drawn toward the actuation electrode, P₂ is generally larger than P₁ for viable cells. Such an embodiment, would be considered a pDEP signal. By contrast, FIG. 8C illustrates an embodiment of a sensor readout for a non-viable cell where an actuation signal is applied. Here, the actuation force causes the non-viable cells to be repelled by the actuation sensor, causing P₂ to be noticeably smaller than P₁. Such an embodiment would be considered an nDEP signal. The viability count may be calculated as the number of pDEP signals detected, divided by the total number of signals detected. Similar process may be employed for sensing other physical properties of the cells or particles.

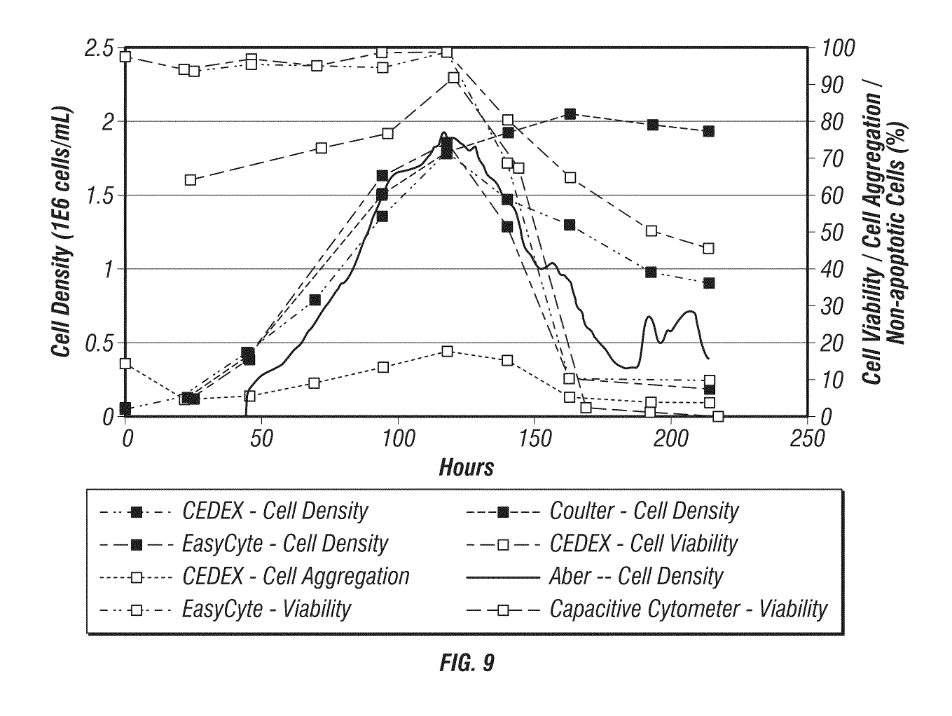

FIG. 9 illustrates a comparison of the performance of a variety of cytometry techniques over a set period of time. From this figure, it can be seen that the capacitive cytometer readings of viability are nearly as good as, if not much better than, other sensing and analysis methods. Some added benefits include the portability and cost effectiveness of the presently described system as compared with the methods listed in FIG. 9. Although EasyCyte viability analysis appears to yield similar results, EasyCyte requires the use of dyes and exposure to UV light in order to analyze samples. Thus, the EasyCyte is more costly and less portable than the present embodiments. Moreover, the present embodiments may be scaled more easily to accomplish bulk electronic measurement of samples.

### EXAMPLE 1

Chinese Hamster ovary (CHO) cells expressing a human-llama chimeric antibody (EG2) 226 for epidermal growth factor receptor (EGFR) are pumped in a liquid suspension having a conductivity σₘ=0.17 S/m through the microfluidic channel in a flow with a parabolic velocity profile. Coplanar electrodes generate non-uniform electric fields in the volume directly above. By making the flow path long enough prior to cells entering the electrode region it can be ensured that ˜90% of cells enter the electrode region at altitudes within 3 to 4 um of one another. The actuation process can be monitored, through the signature S, by keeping track of the changes in altitude before and after the cell enters the actuation region. Initially, a cell is detected as soon as it enters the first electrode region, resulting in a signature amplitude P₁; (2) as it continues on its path over the electrodes, it is subjected to a DEP force in the region of the actuation electrode(s); as a result of the actuation, the cell enters the second detection region at a different altitude, and produces a signature amplitude P₂≠P₁. To quantify the changes in signature S, it is useful to compute a “force index”

$$φ = \frac{{P}_{2} - {P}_{1}}{{P}_{1} + {P}_{2}} ,$$

Positive or negative φ is associated with pDEP or nDEP, respectively; φ=0 corresponds to no actuation. Magnitude of φ is related to the strength of the DEP force that caused the altitude change, and a linear correlation between the two exists for small values of force F_{DEP}. For a very large force, φ tends to ±1.

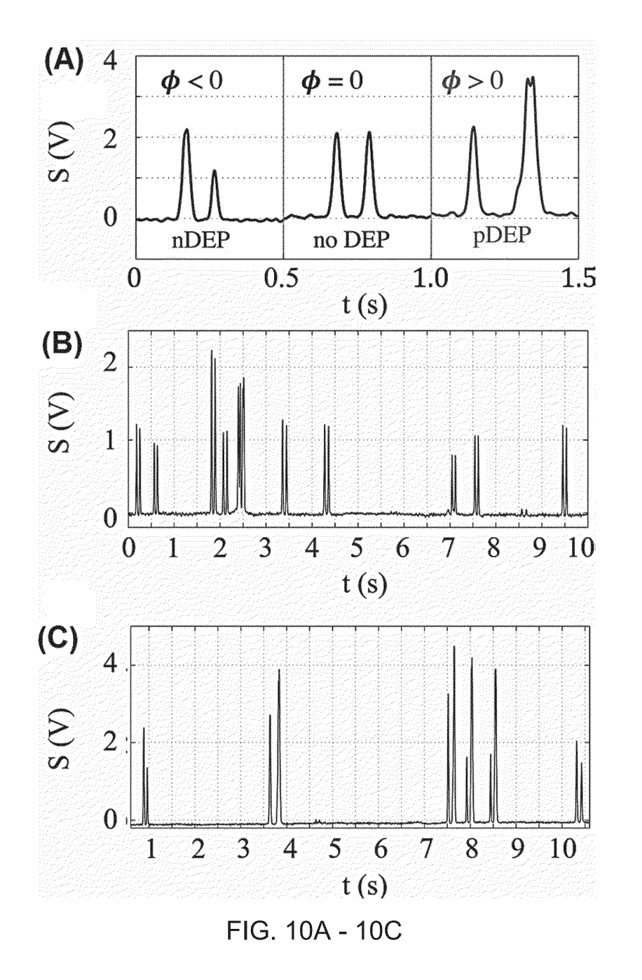

Samples for cell density and viability monitoring were taken every 24 h in the first part of this example and for the first 3 days and then every 6 h for the next 24 h in the second part of the example. Experimental signatures depicted in FIG. 10a were taken from a set of typical signals produced by CHO cells during the experiment, but chosen for cells of similar sizes and entering the actuation region with similar velocities. Hence an almost identical peak, P₁, was produced by all three at the first detection site. Without a DEP force, the cell remains at the same altitude as it flows above the second set of detection electrodes, resulting in a second peak that is practically identical in amplitude and width to the initial one. In contrast, a CHO cell experiencing a pDEP or nDEP force will be deflected downwards or upwards from its original path; in either case, its velocity will change as it enters different fluid layers (Poiseuille flow). A cell that is attracted to the actuation electrodes (pDEP) will slow down, and therefore take longer to both reach the second detection area and pass over it: the resulting electronic signature reveals a wider second peak that is also delayed compared to a control (no DEP) signature. Conversely, the electronic signature of a cell repelled from the actuation electrodes (nDEP) and moving into faster fluid layers will exhibit a narrower second peak that occurs earlier than that of the control signature.

Two of the three signatures in FIG. 10(a) document the CHO cell response at different frequencies: 0.1 MHz (nDEP, φ<0) and 6 MHz (pDEP, φ>0); the remaining one corresponds to a neutral situation with no DEP applied (φ=0). Sweeping the entire frequency region from 0.1 to 6 MHz provides the CMF spectrum. Some samples of experimental signatures are shown in FIGS. 10(b) and 10(c). Study of a population of about 3000 cells reveals a crossover frequency between nDEP and pDEP for healthy viable cells is at 0.5 MHz. By contrast, nonviable cells experience only nDEP through this entire frequency region. This suggests that measurements at the 6 MHz frequency could be used to monitor CHO cells over a period of time and predict the onset of programmed cell death or apoptosis.

### EXAMPLE 2

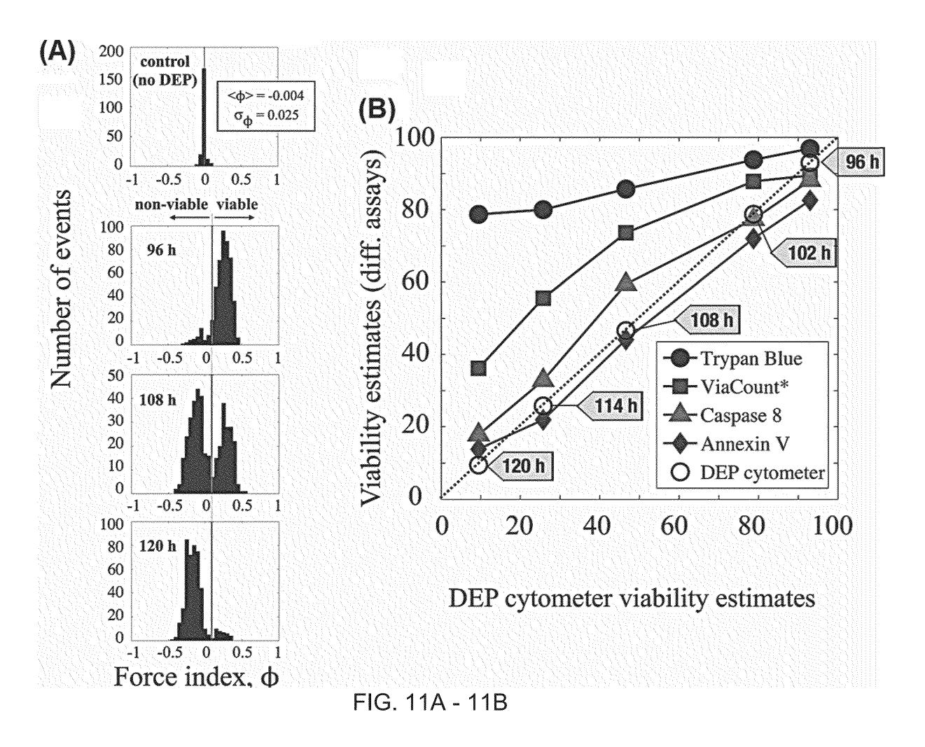

The experimental setup described in Example 1 is repeated with CHO cells involved in a bioprocess. A CHO batch culture was maintained in a bench-top bioreactor for 120 h through growth, stationary, and declining phase; 49 during that time, samples were collected every 24 h, and the dielectric response of the cells was measured by actuating cells at 6 MHz. FIG. 11(a) shows the changes in distribution of force index values, taking part during the final 24 h of the experiment. The pronounced bimodal distributions indicate the presence of at least two different populations of cells: one with φ>0, the other with φ<0. The negative φ population (“non-viable cells”), begins to emerge at about 96 h from the bioreactor seeding. Within 12 h, it starts to take over, and within the next 12 h it almost completely dominates. Note that the mean force index for the population of the unactuated cells (control group) remains very close to 0, demonstrating clearly that the changes in dielectric properties are only observable at megahertz frequencies.

To confirm that the observed changes are related to physiological changes in the cell, in addition to DEP cytometer measurements, cells were monitored during the same 120 h using four standard biological assays. These were trypan blue exclusion test, and three different fluorescent cytometry assays: ViaCount, Annexin V, and caspase 8 (Millipore—Guava EasyCyte HT Base System). Within the final 24 h period (96-120 h from the time of bioreactor seeding), decline in cell viability was noted by all assays. However, since they follow different events in cell physiology, it is typical that the assays disagree on the rate at which the viability declines. Trypan blue selectively colours non-viable cells, but can only enter the cells whose membrane is ruptured (lysed). Thus, trypan blue can only identify necrotic cells, which represent one of the final stages in a cell death process. It is possible for a cell viability to be compromised even though the cell membrane is intact. ViaCount and Caspase 8 assays are both fluorescence flow cytometry assays which bind, respectively, to DNA and caspase 8 protein. Caspase 8 is known to appear inside the cytoplasm in the early stages of cell death. ViaCount assay uses a proprietary mix of two DNA binding dyes—one membrane-permeant and the other membrane-impermeant—to detect viable, apoptotic and dead cells. The membrane-permeant dye is able to get inside the cell before trypan blue molecules do, which accounts for the sequence order in FIG. 11(b). However, one of the earliest events associated with changes in cell viability is the loss of asymmetry of the cell lipid membrane and the appearance of the phosphatidyl serine (PS) head group in the outer leaflet of the lipid bilayer. This event is regarded in the literature as the onset of apoptosis and is customarily detected by fluorescence when protein Annexin V selectively binds to PS heads. From the table and plot shown in FIG. 11(b), it is obvious that the DEP cytometer viability estimates closely follow those of Annexin V assay. Since binding of Annexin V protein to the membrane indicates one of the earliest stages in apoptosis, it may be concluded that the DEP cytometer is sensitive to changes in dielectric properties of the cell associated with this event.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

### REFERENCES

The following references and any others listed herein, to the extent that they provide exemplary procedural or other details supplementary to those set forth herein, are specifically incorporated herein by reference in their entirety.
S. Romanuik, “A Microflow Cytometer with Simultaneous Dielectrophoretic Actuation for the Optical Assay and Capacitive Cytometry of Individual Fluid Suspended Bioparticles,” Thesis, University of Manitoba (2009).

1. An apparatus comprising:
a first sensor electrode configured to sense a physical property of an analyte at a first time;
a second sensor electrode configured to sense a physical property of an analyte at a second time; and
an actuation electrode disposed between the first sensor electrode and the second sensor electrode and configured to apply an actuation force to one or more objects in the analyte.

2. The apparatus of claim 1, wherein the actuation electrode is configured to apply a dielectrophoretic force to a cell in the analyte.

3. The apparatus of claim 2, wherein the dielectrophoretic force is configured to act upon the cell in response to one or more dielectric properties of the cell.

4. The apparatus of claim 2, wherein the dielectrophoretic force is configured to act upon the cell in response to one or more physiological states of the cell.

5. The apparatus of claim 4, wherein the physiological states reflect the onset of programmed cell death.

6. The apparatus of claim 1, wherein the actuation electrode is configured to apply a magnetophoretic force to a cell in the analyte.

7. The apparatus of claim 6, wherein the magnetophoretic force is configured to act upon the cell in response to a magnetic change in the cell.

8. The apparatus of claim 6, wherein the magnetophoretic force is configured to act upon the cell in response to one or more physiological states of the cell.

9. The apparatus of claim 8, wherein the physiological states reflect the onset of programmed cell death.

10. The apparatus of claim 1, wherein the first and second sensor electrodes comprise ground and signal portions.

11. The apparatus of claim 10, wherein each of the actuator electrode, and ground and signal portions of the first and second sensor electrodes has a width of about 25 μm.

12. The apparatus of claim 10, wherein the ground and signal portions are separated from one another by a gap.

13. The apparatus of claim 12, wherein the gap is about 25 μm.

14. A system comprising:
a fluid inlet configured to receive an analyte fluid comprising one or more objects;
a fluid outlet configured to dispense of the analyte fluid;
a sensor element comprising:
a first sensor electrode configured to sense a physical property of the analyte fluid at a first time;
a second sensor electrode configured to sense a physical property of an analyte fluid at a second time; and
an actuation electrode disposed between the first sensor electrode and the second sensor electrode and configured to apply an actuation force to one or more objects in the analyte fluid; and
a fluid channel coupling the fluid inlet to the fluid outlet, and configured to provide at least a portion of the analyte fluid to the sensor element.

15. The system of claim 14, additionally comprising two or more signal generator circuits, each signal generator circuit being coupled to one or more electrodes.

16. The system of claim 15, wherein at least one sensor electrode is coupled to a first signal generator.

17. The system of claim 16, wherein the first signal generator is configured to supply a signal having a frequency of between 0.1-20 MHz.

18. The system of claim 16, wherein the actuator electrode is coupled to a second signal generator.

19. The system of claim 18, wherein the second signal generator is configured to supply an electronic signal having a frequency of about 1.29 GHz.

20. A method comprising:
sensing a physical property of an object in an analyte fluid with a first sensor electrode at a first time;
applying an actuation force to the object in the analyte fluid; and
sensing the physical property of the object in the analyte fluid with a second sensor electrode at a second time.

21. The method of claim 20, wherein the actuation force is applied by an electromagnetic signal.

22. The method of claim 21, wherein the electromagnetic signal has a frequency of between 0.1 and 20 MHz.

23. The method of claim 20, wherein the object in the analyte fluid is a cell.

24. The method of claim 20, further comprising analyzing a first sensor signal provided by the first sensor electrode and a second sensor signal provided by the second sensor electrode to quantify the physical property of the object in the analyte fluid.

25. The method of claim 20, further comprising analyzing a first sensor signal provided by the first sensor electrode and a second sensor signal provided by the second sensor electrode to classify the physical property of the object in the analyte fluid.
